(19) United States
(12) Patent Application Publication
(10) Pub. No.: US 2018/0034343 A1
(43) Pub. Date: Feb. 1, 2018

(54) ELECTRIC MACHINE UNIT WITH GROOVE FOR RECEIVING A PROTECTIVE CAP

(71) Applicant: Robert Bosch GmbH, Stuttgart (DE)

(72) Inventors: Andreas Hoch, Rutesheim (DE); Bernd Schroeder, Renningen (DE); Mario Kaepple, Oehringen (DE); Martin Henger, Tamm (DE); Miguel Cirujano Cuesta, Cuencabuena (ES)

(21) Appl. No.: 15/663,964

(22) Filed: Jul. 31, 2017

(30) Foreign Application Priority Data
Aug. 1, 2016 (DE) 10 2016 214 131.7

(51) Int. Cl. H02K 5/22; H02K 11/33; H02K 1/14; H02K 5/24; H02K 11/02

(52) U.S. Cl. CPC H02K 5/22; H02K 5/24; H02K 11/02; H02K 1/145; H02K 11/33; B60K 6/485

(57) ABSTRACT

An electric machine unit (1) having an electric machine (10), having power electronics (20) mounted thereon, and having a protective cap (130) for the power electronics (20), wherein the protective cap (130) has a top side and has a side wall (131) with a free edge (132), wherein the side wall (131) of the protective cap (130) is, at the free edge (132), arranged at least in sections in a groove (121).

### BACKGROUND OF THE INVENTION

The present invention relates to an electric machine unit having an electric machine and having power electronics mounted thereon.

Electric machine units having an electric machine and having power electronics mounted thereon are used for example in motor vehicles as starters or generators or in combined form as starter-generators or so-called boost recuperation machines (BRM). They may have, for example, a separately excited electric machine with rotor winding (exciter winding) and stator winding and, as power electronics, a power converter with regulator (e.g. generator regulator or field regulator) which is connected downstream of the stator winding and which regulates the voltage generated by the electric machine and/or the torque generated by the electric machine.

To protect the electrical phases against being touched, the power electronics should be covered by means of a protective cap. In the case of relatively high voltages, such as are used for example in the case of BRMs (48 V), the protective cap should be electrically conductive in order to maintain the electromagnetic compatibility (EMC). This is expedient because, with 48 V rated voltage and PWM actuation of the electrical phases, the emission of electromagnetic waves is several times greater than in the case of conventional 12/14 V machines.

During the operation of the electric machine, vibrations arise which lead to oscillation of the electric machine with power electronics. As a result, the protective cap is also caused to oscillate. These inherent oscillations of the protective cap can lead to damage to the protective cap or to adjacent components. Furthermore, disturbing noises can arise as a result of the oscillations. To prevent or at least minimize the oscillations of the protective cap, the protective cap may be fixed by means of multiple bolts through the top side thereof.

### SUMMARY OF THE INVENTION

According to the invention, an electric machine unit having an electric machine and having power electronics mounted thereon is proposed.

The invention proposes that the protective cap for the power electronics be fixed not only at the top side but also at the side wall by virtue of the side wall being, at its free edge, arranged at least in sections in a groove.

Specifically, it has been found that the fixing at the top side is on its own not sufficient to suppress vibrations, because the side walls of the protective cap are also caused to oscillate. The groove fixes the side wall of the protective cap in a radial direction. As a result, an oscillation of the side wall is prevented or at least reduced.

The groove is preferably formed at least in sections as a U-shaped depression. This shape is particularly easy to produce and is insensitive during the assembly process.

A connection plate which is arranged between electric machine and power electronics preferably has the groove. Such connection plates between electric machine and power electronics may be used in the conventional manner for providing electrical contact elements for the phases that are led out of the electric machine, to which contact elements the power electronics are then connected. At the same time, the connection plate may provide fastening means for the fastening of the power electronics.

The connection plate is preferably formed from plastic. Therefore, it is firstly the case that the plate itself and also the groove situated thereon are easy to produce, in particular by injection molding (plastics injection-molded part), and secondly, the connection plate simultaneously has an electrically insulating action. It is preferably possible for molds for conventional connection plates to be further developed to include a groove. The fixing is thus virtually cost-neutral, because only a slightly greater amount of plastics material is required for the connection plate.

The groove expediently runs on the outer edge of the connection plate, wherein it is expediently the case that more than 10%, 20%, 30%, 40%, 50%, 60%, 70%, 80%, 90% of the circumference is covered.

The groove preferably has alignment means which align the protective cap relative to the electric machine with respect to a rotation about an axis perpendicular to the top side of the protective cap. This facilitates the alignment of the protective cap on the electric machine, which permits reliable insertion of the fastening bolts.

The alignment means preferably have at least one groove delimitation, in particular a groove discontinuation or groove interruption. The groove is thus not a continuous groove but is a groove which is delimited, in particular interrupted, at points or in sections, wherein the protective cap expediently has corresponding interruptions in the free edge of the side wall in order to permit an engagement of interrupted edge and interrupted groove into one another. The invention is inexpensive to implement because it is merely necessary for the mold for the connection plate to be slightly modified.

For simplified assembly, the groove delimitation and/or the side wall may have an insertion bevel.

The protective cap is preferably electrically conductive in order to improve the electromagnetic compatibility. It may for example be metallic, composed of electrically conductive plastic, or composed of plastic with an electrically conductive coating.

It is furthermore preferable if the protective cap has a burr at its free edge. This embodiment enables the side wall to be wedged in the groove, which results in a particularly secure hold. The holding force is increased and the side wall lies in the groove without play. In particular if the protective cap is produced as a deep-drawn part composed of a metal sheet, a burr is formed at the free edge of the side wall as a result of the punching process. The burr protrudes outwardly or inwardly depending on the punching direction and has a sharp edge. It is particularly advantageous for precisely this punching burr to be utilized for the optimized fixing of the side wall in the groove.

Further advantages and refinements of the invention will emerge from the description and from the appended drawing.

### BRIEF DESCRIPTION OF THE DRAWINGS

The invention is illustrated schematically on the basis of an exemplary embodiment in the drawing and will be described below with reference to the drawing.

FIG. 1 shows an electric machine unit according to a preferred embodiment in a perspective view.

FIG. 2 shows a longitudinal section through the electric machine unit from FIG. 1.

FIG. 3 shows the detail outlined in FIG. 2, regarding the arrangement of a side wall of the protective cap in a groove of a connection plate, in an enlarged view.

FIG. 4 shows the protective cap and the connection plate separately in a perspective view.

FIG. 5 shows an enlarged detail of the free edge of the protective cap with punching burr.

FIG. 6 shows the electric machine unit from FIG. 1 in a perspective view from above.

FIG. 7 shows the detail outlined in FIG. 6, regarding the alignment of the side wall of the protective cap in the groove of the connection plate, in an enlarged view.

### DETAILED DESCRIPTION

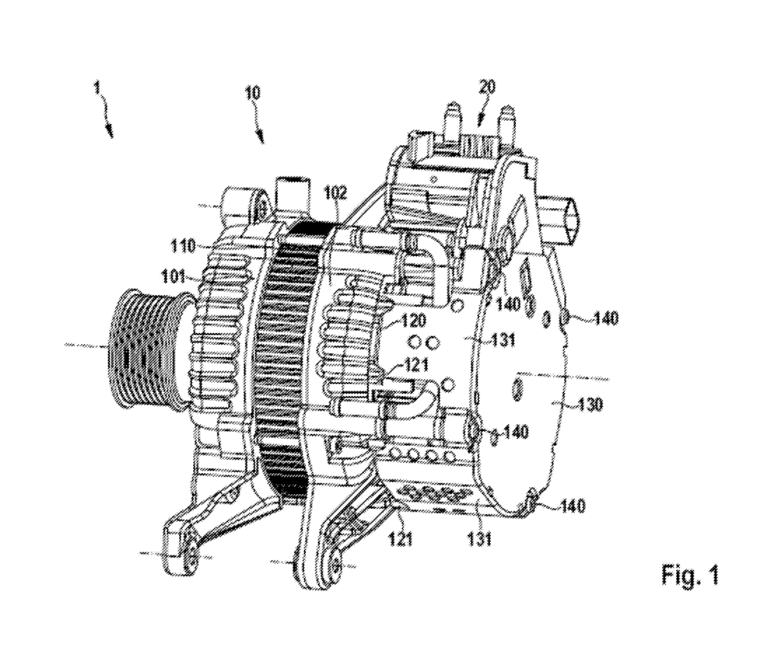

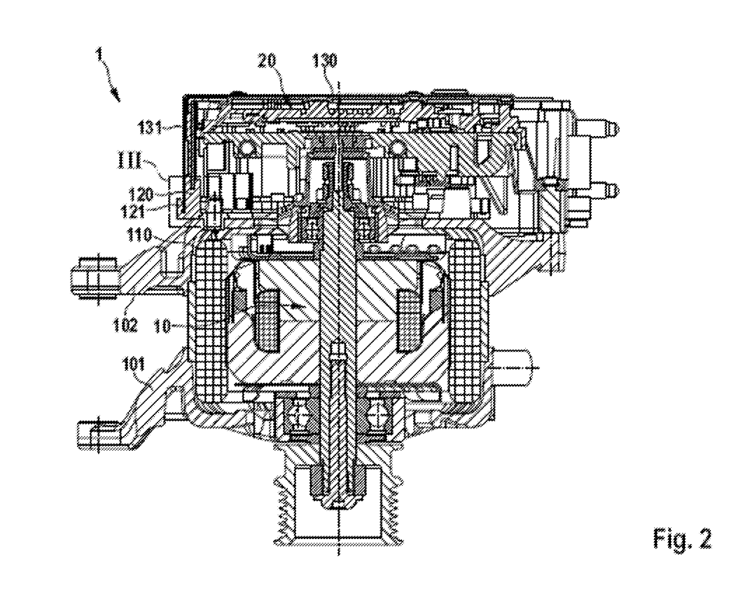

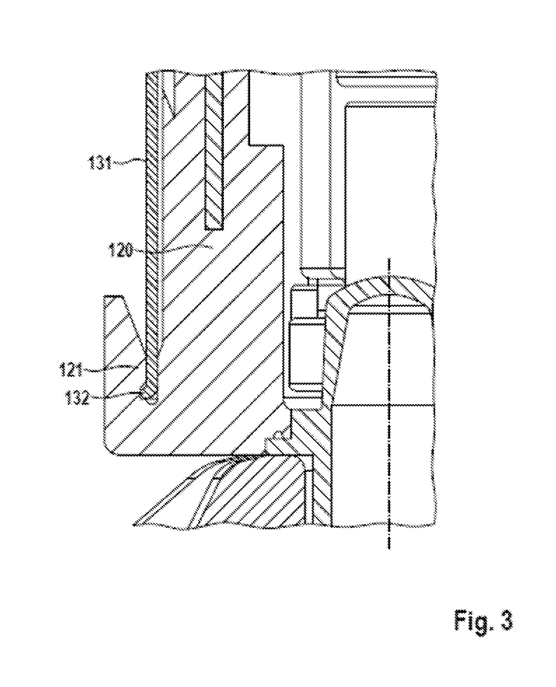

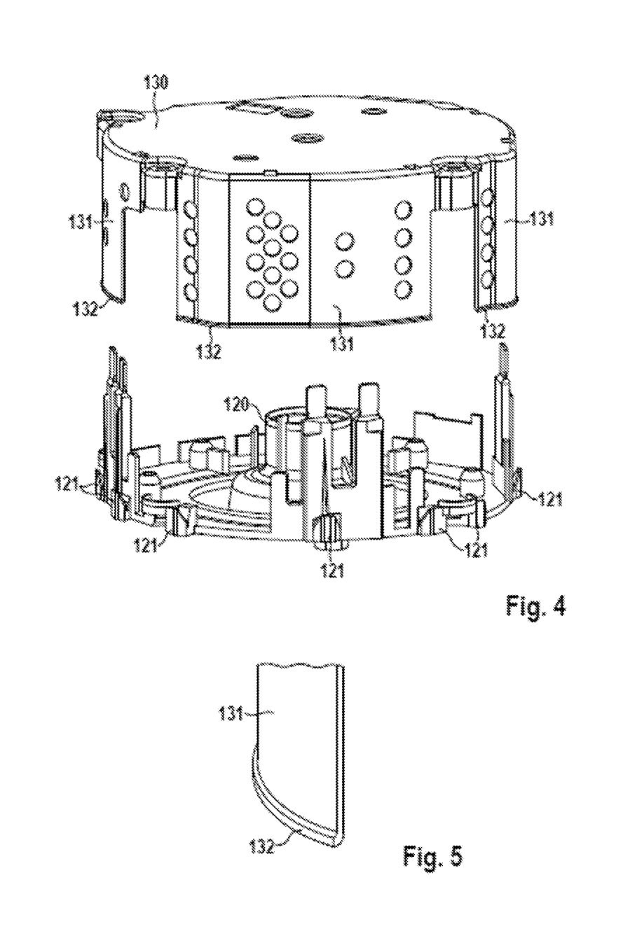

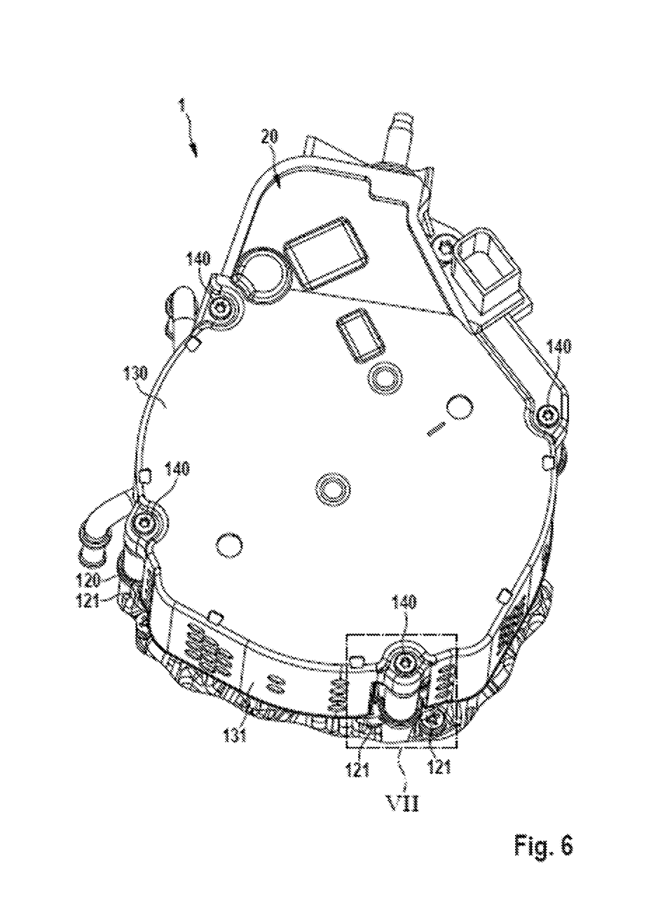

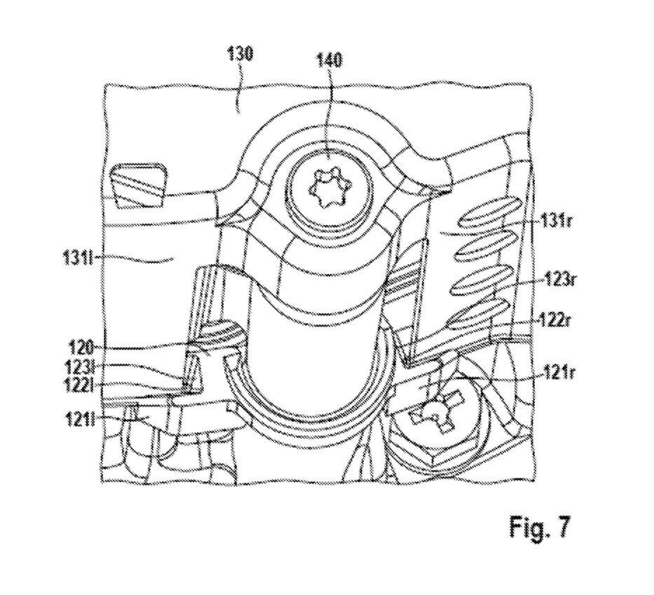

Firstly, on the basis of FIGS. 1 to 5, an overall description will be given of a preferred embodiment of an electric machine unit 1 according to the invention, with an advantageous refinement illustrated in FIGS. 6 and 7 then being described.

The electric machine unit 1 is for example in the form of a boost recuperation machine (BRM) for a boost recuperation system (BRS) and has a claw-pole machine 10 as an electric machine and power electronics 20 mounted thereon. Said electric machine unit has for example a rated voltage of 48 V.

The housing of the claw-pole machine 10 is composed substantially of two bearing plates 101 and 102 with mounting arms for the fastening of the electric machine unit for example to the internal combustion engine. The bearing plates fix the stator 110.

Between the claw-pole machine 10 and the power electronics 20 there is situated a connection plate 120. The connection plate 120 is in this case in the form of a plastics injection-molded part and serves inter alia for the contacting of the electrical phases of stator 110 and power electronics 20.

A protective cap 130 largely covers the power electronics 20. The protective cap is, at its top side, held on the claw-pole machine 10, specifically on the bearing plate 102, by means of bolts 140. A side wall of the protective cap is denoted by 131. Furthermore, in the preferred embodiment illustrated here, an in this case outwardly projecting punching burr is situated at the free edge 132 of the side wall 131. The punching burr is formed for example during the process of production of the protective cap. It protrudes outwardly or inwardly depending on the punching direction and has a sharp edge.

The connection plate has multiple grooves distributed over the circumference and formed in this case as U-shaped receptacles 121 (or one groove with multiple interruptions) for the lateral fixing of the protective cap, wherein the side wall 131 engages at its free edge 132 into the groove 121.

The punching burr at the free edge 132 of the protective cap can additionally, during the assembly process, become wedged in the plastics material of the U-shaped receptacle 121 of the connection plate. The lateral fixing of the protective cap is thereby improved.

The lateral fixing of the protective cap by means of U-shaped receptacles on the connection plate is inexpensive to implement, because only a slightly greater amount of plastics material is required.

FIG. 6 shows a preferred refinement of the electric machine unit 1 obliquely from above, in order to illustrate the region of the alignment means, which in this case is in the form of a groove delimitation.

FIG. 7 shows an enlarged detail from FIG. 5 with an illustration of two U-shaped receptacles 121l (left) and 121r (right) of the connection plate 120, with alignment means formed in this case as a groove delimitation or groove discontinuity 122l, 122r.

The left-hand groove delimitation 122l delimits the travel of the left-hand side wall 131l and thus a rotation of the protective cap about an axis perpendicular to the top side toward the right. The right-hand delimitation 122r delimits the travel of the right-hand side wall 131r and thus a rotation of the protective cap about an axis perpendicular to the top side toward the left. Thus, altogether, the angle range of the alignment of the protective cap about an axis perpendicular to the top side is restricted, such that insertion of the fastening bolts 140 is made easily possible.

To simplify the mounting of the protective cap 130, the groove delimitations 122 have insertion bevels 123l and 123r. Alternatively, the insertion bevel may also be provided on the side wall of the protective cap.

The lateral fixing by means of U-shaped receptacles with groove delimitation can be implemented inexpensively, because only a slightly greater amount of plastics material is required on the connection plate.

1. An electric machine unit (1) having an electric machine (10), having power electronics (20) mounted thereon, and having a protective cap (130) for the power electronics (20), wherein the protective cap (130) has a top side and has a side wall (131) with a free edge (132), wherein the side wall (131) of the protective cap (130) is, at the free edge (132), arranged at least in sections in a groove (121).

2. The electric machine unit (1) according to claim 1, wherein the protective cap (130) is fastened by means of bolts (140) extending through the top side of said protective cap.

3. The electric machine unit (1) according to claim 1, wherein the groove (121) is formed at least in sections as a U-shaped depression.

4. The electric machine unit (1) according to claim 1, having a connection plate (120) which is arranged between the electric machine (10) and the power electronics (20), wherein the connection plate (120) has the groove (121).

5. The electric machine unit (1) according to claim 1, wherein the groove (121) has alignment means (122l, 122r) which align the protective cap (130) relative to the electric machine with respect to a rotation about an axis perpendicular to the top side of the protective cap.

6. The electric machine unit (1) according to claim 5, wherein the alignment means (122l, 122r) comprise at least one groove delimitation.

7. The electric machine unit (1) according to claim 5, wherein the alignment means (122l, 122r) have at least one insertion bevel (123l, 123r).

8. The electric machine unit (1) according to claim 1, wherein the side wall (131l, 131r) has at least one insertion bevel (123l, 123r).

9. The electric machine unit (1) according to claim 1, wherein the protective cap (130) is electrically conductive.

10. The electric machine unit (1) according to claim 1, wherein the protective cap (130) has metal and/or electrically conductive plastic.

11. The electric machine unit (1) according to claim 1, wherein the protective cap (130) has an electrically conductive coating.

12. The electric machine unit (1) according to claim 1, wherein the protective cap (130) has an outwardly or inwardly protruding burr on its free edge (132).
